(19) United States
(12) Patent Application Publication
(10) Pub. No.: US 2026/0255176 A1
(43) Pub. Date: Aug. 27, 2026

(54) METHOD FOR OPTIMIZING AN ASSIGNMENT OF FREQUENCIES TO CELLS IN A MOBILE COMMUNICATIONS NETWORK

(71) Applicants: Fujitsu Technology Solution GmbH, München (DE); Deutsche Telekom AG, Bonn (DE)

(72) Inventors: Fritz Schinkel, München (DE); Christian Münch, München (DE); Sebastian Engel, München (DE); Marc Geitz, Hagen (DE); Oliver Holschke, Berlin (DE); Christine Crisan, Bonn (DE)

(73) Assignees: Fujitsu Technology Solution GmbH, München (DE); Deutsche Telekom AG, Bonn (DE)

(21) Appl. No.: 18/856,363

(22) PCT Filed: Apr. 4, 2023
(86) PCT No.: PCT/EP2023/058816

§ 371 Date: Oct. 11, 2024

(30) Foreign Application Priority Data
Apr. 12, 2022 (EP) 22167880.8

(51) Int. Cl. H04W 16/10; H04B 17/309

(52) U.S. Cl. CPC H04W 16/10; H04B 17/346

(57) ABSTRACT

A computer-implemented method optimizes frequency assignments in a mobile communications network by specifying unplanned cells and potential frequencies for each cell, calculating frequency interference probabilities between cell pairs, formulating a stress function with terms connecting interference probabilities and frequency relations, and using a quantum concept processor to minimize the stress function for optimized frequency assignments.

### CROSS REFERENCE TO RELATED APPLICATIONS

This application is a US national stage filing under 35 U.S.C. § 371 of International Application No. PCT/EP2023/058816, filed Apr. 4, 2023, which claims priority to European Patent Application No. 22167880.8, filed Apr. 12, 2022, each of which is incorporated herein by reference in its entirety.

### TECHNICAL FIELD

This disclosure relates to a computer-implemented method for optimizing an assignment of frequencies to cells of a mobile communications network, the cells being distributed for communication within the mobile communications network as well as to a quantum concept processor configured to perform such a method and a computer program implemented to perform such a method.

### BACKGROUND

Communication demands regarding traffic in mobile communications networks are continuously increasing. More and more devices and applications push mobile communications to new peaks. Moreover, the increasing demand of digitized and decentralized mobile working as well as increasing streaming demands are other big contributors to this trend. These increasing amounts of data being transported through mobile communications networks accompanied by a requirement for increased network capacity impose a significant challenge to Service Providers.

Mobile communications networks, in particular mobile phone networks, e.g. 2G-networks like GSM or TETRA, comprise a topology of distributed “cells” for transmitting, receiving and forwarding mobile communication traffic and control data within the network via radio frequency communication. Each cell acts as a mobile communication node covering a certain area for mobile communications networking, thereby using one or more communication frequencies. Mobile communication participants, like mobile phones and other cellular or radio communication devices, connect to a respective cell for mobile communication with other participants in the communications network.

Depending on the location and characteristics of the surroundings of the cells (e.g. urban areas vs. rural areas) and depending on the number and density of participating devices, the cells differ in collections of frequencies assigned to them to reliably handle the amount and volume of communication traffic. The frequencies are used for data or conversation transmissions, control channels and more. To avoid congestion in mobile communications networks and degradation of user experience, mobile phone providers, hence, are interested to make the best possible use of a provided frequency spectrum.

The capacity of a mobile communications network can be enhanced by assigning frequencies from the frequency spectrum of the mobile network operator to cells in a dense way. However, this may have the disadvantage that frequencies of neighboring cells violate a necessary distance requirement. For example, if frequencies of neighboring or otherwise related cells are equal or adjacent in the frequency spectrum, they interfere with each other. This leads to signal interference, degradation of communication quality or communication failure.

One possibility to solve the problem of frequency assignment in cellular communication networks comprises a two-step approach. In a first step, a preliminary assignment is made with regard to the conditions to be fulfilled (hard constraints) such as conditions for neighboring cells. The second step consists of an iterative brute force local optimization at unsaturated cells. For each such cell a ring of direct neighboring cells is re-planned. If no satisfactory solution is found, the procedure can be repeated with a wider ring, which is the union of all cells from the neighboring rings of directly adjacent cells, from the first step of ring generation. This ring-based cell collection procedure can be performed recursively. However, such conventional approaches have the disadvantage that local optimization at unsaturated cells can deteriorate the interference at other cells within the network or even lead to the fact that a required number of frequencies is not or only insufficiently allocated to certain cells. Moreover, such conventional approaches have the disadvantage that optimization techniques applied so far quickly reach their limits.

It could therefore be helpful to provide enhanced techniques that allow for an optimized assignment of demanded frequencies to cells of a mobile communications network, thereby avoiding intra-cellular and inter-cellular interference and enhancing an optimized frequency usage within a network.

### SUMMARY

We provide a computer-implemented procedure for optimizing an assignment of frequencies to cells of a mobile communications network, the cells being distributed for communication within the mobile communications network.

In the following we will refer to “unplanned cells” as mobile network cells defined by the coverage areas of antennae, which must get one or more frequencies assigned to them.

We also provide a method that includes specifying a set of unplanned cells in the mobile communications network, specifying for each unplanned cell a set of frequencies to be potentially assigned to this unplanned cell, calculating frequency interference probabilities of selected cell pairs, wherein each cell pair defines a relation of an unplanned cell to another cell within the mobile communications network, formulating terms of a stress function, each term connecting a calculated frequency interference probability of a respective cell pair with a frequency relation between the cells of the respective cell pair, and determining, by using a quantum concept processor, an optimized assignment of frequencies by selecting for each unplanned cell a sub-set of frequencies from the respective set of frequencies, such that the stress function is minimized.

### BRIEF DESCRIPTION OF THE DRAWINGS

FIG. 1 shows an exemplary configuration of a communications network with a plurality of cells.

FIG. 2 shows an exemplary frequency assignment to one cell of the network according to FIG. 1.

FIG. 3a shows an exemplary schematic illustration of a cell neighborhood condition between an exemplary pair of cells of the network according to FIG. 1.

FIG. 3b shows an exemplary schematic illustration of a cell sector condition between exemplary cells of the network according to FIG. 1.

FIG. 4 shows an exemplary schematic illustration of a frequency interference probability condition between an exemplary pair of cells of the network according to FIG. 1.

FIGS. 5 to 11 show exemplary mathematical formulations of partial optimization problems.

FIG. 12 shows an exemplary schematic illustration of a frequency assignment algorithm.

List of reference signs

| | |
|---|---|
| 1 | communications network |
| 2 | unplanned cells |
| 3 | participants |
| 4 | neighborhood |
| 5 | sector |
| 6 | planned cells |
| 7 | quantum concept processor |
| 8 | subset of unplanned cells |
| a1 to aN | antennae |
| C | set of all Cells |
| c, c1 to cN | single cells |
| co | co-channel |
| adj | adjacent channel |
| BCCH | broadcast channel frequency |
| TCH | traffic channel frequency |
| NB | neighborhood relation |
| SEC | sector |
| E1, E2 | terms of frequency demand condition |
| f | frequency |
| p | frequency interference probability |
| t | threshold |
| w | number of demanded frequencies |
| x | frequency variable |

### DETAILED DESCRIPTION

Our method reliably tackles the problem of assigning frequencies to unplanned (or to be planned) cells in a communications network such that for most of (or ideally all) unplanned cells a required sub-set of selected frequencies can be assigned according to the cell's frequency demand. The assignment fulfils certain neighborhood conditions between adjacent cells. Optionally, an overall frequency interference between the cells in the mobile communication network is minimized.

By applying the method, for every given unplanned cell, an optimal assignment of a sub-set of frequencies from the set of frequencies potentially to be assigned to this cell can be selected. The selection is automatically chosen such that intra-cellular and inter-cellular frequency interferences can be minimized and nevertheless a dense frequency usage over the whole frequency spectrum available within a network can be enhanced.

Each sub-set of frequencies reflects a certain demanded number of frequencies per cell or certain demanded frequencies of the frequency spectrum per cell. In other words, this means that for a certain demand number of frequencies per cell a subset of the cell's frequency spectrum of that size (=cardinality) has to be determined. Frequencies are defined as discrete frequency bands or channels, e.g. of a GSM network. Cells are defined e.g. as a certain regional coverage of mobile communication by one or more antennae for radio communication. Depending on the transmission power characteristics and installation of an antenna as well as the topology of its surroundings, the areal coverage of the cell spanned by the antenna can vary.

An exemplary mobile communications GSM network comprises thousands of GSM cells and tens or hundreds of frequency bands or channels, wherein a small number of channels (approx. <10, e.g. 2 to 6) is to be used per cell.

Frequency relations describe frequency-dependent expressions defining a (potential) relation of one or more frequencies of one cell to one or more frequencies of the other cell of each respectively defined cell pair. For example, the frequency relations describe certain combinations of selected frequencies for both cells of a cell pair that may lead to an interference between the cells of the cell pair with the respectively calculated frequency interference probability.

The cell pairs describe relations of each cell from the set of unplanned cells to another cell within the mobile communications network. The other cell can be a cell from the set of unplanned cells to which frequencies are to be assigned. Alternatively, the other cell can be a cell within the mobile communications network that is not within the selected set of unplanned cells. This may be e.g. a formerly planned cell with pre-assigned frequencies or a cell with fixed frequencies, which may stem, for example, from previous assignments.

For example, a frequency assignment FA can be described as a mapping from the set of cells to the power set (set of sub-sets) of the frequencies. A cell-pairwise interference probability can then be defined as real valued function on FA x FA assigning to each cell pair of “frequency assigned cells” a probability for disturbance. For the frequency assignment in total an interference probability can be defined (e.g. as the sum of pairwise interference probabilities for all non-diagonal pairs of FA x FA). This is not a probability itself (e.g. value can be >1) but it can be taken as a degree of disturbance in the whole network. The method can be implemented to search in the set of all possible frequency assignments FA one with minimum interference probability. Further constraints can optionally be taken into consideration, which is explained below.

By calculating frequency interference probabilities of selected cell pairs and formulating terms of a stress function, each term thereby connecting a calculated frequency interference probability of a respective cell pair with a frequency relation between the cells of the respective cell pair, a stress function (cost function) of the above-explained optimization problem can be constructed. Such stress function penalizes frequency relations that lead to significant interference between cells. The stress function and, hence, the underlying optimization problem can be formulated as a quadratic unconstrained binary polynomial.

In this way, an optimized assignment of frequencies to unplanned cells is determined by selecting for each unplanned cell a sub-set of frequencies from the respective set of frequencies, such that the stress function is minimized. The minimum of the stress function preferably is a global minimum, but can also be a local minimum.

The method, hence, has the technical effect and advantage of an optimized coverage of cells with demanded numbers of frequencies for optimal per cell frequency utilization depending on the location and characteristics of the surroundings of the cells and depending on the requested demand, which is derived from the expected number and density of communication participants. Additionally, a minimization of interference can be reached in an optimal manner. Hence, user experience can be enhanced and degradation of communication quality or communication failure can be avoided. Moreover, costs for installation and maintenance of cells can be lowered, since a number of required cells may be reduced due to an optimized frequency assignment. Furthermore, the method has the effect and advantage that a solution of an optimized assignment of frequencies to unplanned cells is determined/calculated very fast which enables the possibility of a very quick re-planning/re-assignment of frequencies to respective cells.

The underlying optimization problem may be very complex. This is not only due to a potential impact of frequencies of one cell to frequencies of other cells. The problem is also very complex because there are many practical constraints that have to be taken into account. As more constraints are implemented, such problems become more complex and difficult to solve. This is problematic or difficult, if solutions are needed fast, for example, if a frequency re-assignment to certain cells is required as a reaction to an unexpected network failure or during maintenance. But also under consideration of further practical constraints like neighborhood relations between cells or a dense agglomeration of cells in so called “sectors”, for example, several antennae on a roof top within urban areas or cities, such calculations are difficult to solve. Our method advantageously shows its strength compared to conventional approaches more and more, the more complex the underlying problem is. In other words, for a complex optimization problem taking into consideration practical constraints as explained above, our method has a significant strength over conventional techniques.

One advantage of our procedure is the automatic solution of the optimization problem without manual adjustments, like the number of rings in the conventional approach as stated above. The runtime is shorter compared to the state of the art procedures and the solution quality is better, since more required frequencies can be reliably assigned to more cells in the network. The described procedure is a hybrid approach between pre-processing steps (formation of the set of unplanned cells and/or formation of the respective set of frequencies to be potentially assigned to each unplanned cell) and solution steps by quantum concept processors.

Our method makes use of an approach inspired by quantum computing. The calculation of optimized solutions of the stress function for determining an optimized assignment of frequencies to all cells of the set of unplanned cells is performed by a so-called quantum concept processor. As a quantum concept processor in the context of the present disclosure a processor is defined that solves a so called “Ising model” or the equivalent quadratic unconstrained binary problem. For example, this is a processor configured to solve an optimization problem of quantum annealing or quantum annealing emulation. Such a processor is, for example, based on conventional hardware technology, for example, based on complementary metal-oxide-semiconductor (CMOS) technology. An example of such quantum concept processor is a Fujitsu digital annealer. Alternatively, any other quantum processors can be used for our method, in future times also such technologies that are based on real quantum bit technologies. Further examples of such quantum concept processors are the DWave quantum annealer (e.g. 5000Q), but also quantum gate computers (IBM, Rigetti, OpenSuperQ, IonQ or Honeywell) and their future successors or alternative QC designs making use of quantum optimization algorithms like Quantum Approximate Optimization Algorithm (QAOA) or Variational Quantum Eigensolver (VQE).

In other words, a quantum concept processor is a processor that realizes the concept of minimization of a so-called quadratic unconstrained binary optimization (QUBO) function, either on a special processor based on classic technology, a quantum gate computer or on a quantum annealer.

The method may further comprise the following steps:
specifying frequency variables, wherein each frequency variable is associated with one cell within the mobile communications network and one frequency for this cell,
formulating the frequency relations in the terms of the stress function as combinations of selected frequency variables, and
calculating the terms of the stress function, by using the quantum concept processor to set the frequency variables, such that the stress function is minimized.

The frequency for the cell which a respective frequency variable is associated with is e.g. one frequency from the set of frequencies to be potentially assigned to this cell, if the cell is a still unplanned cell. Alternatively, such frequency is e.g. one frequency that has already been assigned to the cell, if the cell is planned already. The value of the frequency variable is a priori known, depending on whether the frequency is assigned to the cell (value one) or not (value 0). Such fixed variables do not have to be optimized by the quantum concept processor but may lead to restrictions for unplanned cells and thus be part of some linear terms of the stress function. The actual number of frequency variables to be optimized are only those coming from unplanned cells. For example, for n cells with m frequencies per cell, at least n×m frequency variables may be specified.

In this way, for each unplanned cell an optimal assignment of frequencies can be calculated individually by respectively setting the frequency variables, such that the stress function is minimized. This offers an elegant example of a very flexible and variable frequency assignment. Different sub-sets of frequencies for different cells can be selected to avoid disturbing interference between the cells or a critical increase of interference in the network. Moreover, a dense frequency usage can be achieved over distributed cells throughout the network in an optimized manner.

The formulation of the frequency relations in the terms of the stress function as combinations of selected frequency variables allows for the calculation of an optimized solution (minimum) of the stress function for all unplanned cells in a flexible manner taking into consideration various frequency approaches that may lead to different disturbing interference behaviors between the cells. In this way, an optimized selection of different sub-sets of frequencies for all unplanned cells can be achieved to minimize the cost function of the above-explained optimization problem. An impact of selected frequencies of one cell to other (potentially assigned) frequencies of other cells can be mitigated. This allows for a very high degree of freedom in the frequency assignment, which nevertheless is very complex to solve. An optimized selection of respective sub-sets of frequencies for all unplanned cells is performed by the quantum concept processor, as explained above.

In the terms of the stress function only calculated frequency interference probabilities are considered that are below a predetermined threshold. Hence, the optimization only considers interference probabilities that do not exceed a certain limit. This prevents certain frequencies to be assigned to certain cells which may lead to intolerable interference between these cells. For example, interference probabilities exceeding the threshold are avoided by penalty terms which are forced to zero for an optimum solution by a large prefactor.

The method is performed under consideration of a frequency demand condition such that each sub-set of frequencies assigned to an unplanned cell has a specified number of frequencies. One frequency is defined as control channel frequency and the other frequencies are defined as traffic channel frequencies. In different examples, the control channel frequency can be exactly one or at least one frequency of each cell. The number of frequencies to be assigned to a respective cell is e.g. preselected or predetermined, for example, under consideration of the topology of the mobile communications network, location and/or cellular characteristics of each cell (depending on power transmission performance and/or topology of surroundings of the cell) as well as the number and density of participants that want to dial into the cell for mobile communication.

According to the frequency demand condition, each cell must be assigned one control channel frequency. One control channel frequency is necessary for each cell and is the purpose of providing a control channel for the cell via which signaling and control information is exchanged between the cell and other cells or the cell and different network elements, terminals or participants. When the mobile communications network is implemented according to the GSM standard, such control channel frequency e.g. is a so-called broadcast channel (BCCH) frequency according to the GSM standard. Further according to the frequency demand condition, the other frequencies assigned to the cell are defined as traffic channel frequencies. The purpose of providing one or more traffic channels for the cell over which communication traffic, like data or voice, is transmitted and exchanged between the cell and other cells or the cell and different network elements, terminals or participants. When the mobile communications network is implemented according to the GSM standard, such traffic channel frequencies e.g. are so called transmission channel (TCH) frequencies according to the GSM standard.

In terms of communication control between the cells in the mobile communications network, the control channels have a more fundamental role than the traffic channels. In certain examples, control channels are configured to also transmit communication traffic besides signaling and control information. In other examples, control channels are configured to only transmit signaling and control information.

The method is performed under consideration of a frequency combiner distance condition that for each unplanned cell forbidden frequency relations are defined such that the frequencies of the sub-set of frequencies assigned to this cell have frequency relations with a certain channel distance. For example, the channel distance is equal to or greater than two. The frequency combiner distance condition, hence, has the effect that an intra-cell frequency interference can be minimized or completely avoided, since the frequencies used by each cell have to meet a certain channel distance to each other.

The method is performed under consideration of a cell neighborhood condition such that for those cells which have a determined (handover) neighborhood relation forbidden frequency relations between these cells are defined. The neighborhood relation, in particular, relates to neighboring cells (for example, selected cell pairs or a plurality of cells) that provide an overlap in their area coverage. This is important in view of a so-called handover between neighboring cells. If a participant during ongoing usage of the mobile communication network moves away from the antenna (center) of one cell, its transmission level decreases. As soon as the participant reaches the area of the next neighboring cell, the participant must be handed over from the first cell to the second cell to continue usage of the mobile communication network. If in such an approach certain frequency relations were used, the inter-cell frequency interference between such neighboring cells would increase beyond a critical limit. Necessary calculations for a handover may be disturbed by interference and can be erroneous or fail, there being a risk that the handover fails and the participant is confronted with an aborted communication in the mobile communication network. The cell neighborhood condition hence defines forbidden frequency relations between neighboring cells to avoid critical frequency interference between these cells and, in particular, prevent potential drawbacks of handover failure.

The method is performed under consideration of a cell sector condition that for those cells which have a determined sector relation forbidden frequency relations between these cells are defined. The cell sector relation, for example, relates to cells within a predetermined dense installation area or location, where multiple antennae of different cells are installed close to each other, e.g. on a roof top, in a street or in a dense urban area, etc. Inter-cell interference may be significant due to the dense installation and overlap of the different cells. In a sector, therefore, forbidden frequency relations between cells are very important to prevent communication failure. The cell sector condition may be more restricting than the cell neighborhood condition, which means that the cell sector condition defines stricter rules for forbidden frequency relations than the cell neighborhood condition.

The method is performed under consideration of a frequency interference probability condition such that forbidden frequency relations between the cells of those cell pairs in the mobile communications network are defined whose frequency interference probabilities are above a predetermined threshold. In this way, an inter-cell frequency interference can be kept in tolerable limits over the whole network to prevent adverse effects leading in the worst situation to communication failure. Even if an overall assignment of frequencies results in an increased interference probability between some cells or in certain regions of the network after all unplanned cells have been planned and assigned their sub-sets of frequencies, the local and global interference probability can nevertheless be kept in tolerable limits.

The frequency relations of the kinds explained above distinguish between co-channel frequency relations and adjacent channel frequency relations. The co-channel frequency relations consider frequencies of a same channel. The adjacent channel frequency relations consider frequencies of adjacent channels. Adjacent channels mean directly neighboring frequency channels. For example, channels f3 and f4 are adjacent channels, whereas channels f3 and f5 are not adjacent channels.

Co-channel and adjacent channel frequencies are considered to contribute to interference within one cell or between respective cell pairs. Generally, co-channel frequencies have high impact on interference, since the frequencies use the same channel. If frequencies of adjacent channels are used, the impact on interference is not so high, compared to co-channel frequencies. However, also between frequencies of adjacent channels, interference can be problematic, since such frequencies have a small frequency distance (frequency band distance is small). If, for example, two or more of the frequencies assigned to one cell were co-channel or adjacent channel frequencies, high interference would pose a problem and heavily affect communication quality of this cell or result in communication failure. Analogously, if two cells with a certain relation, e.g. a neighborhood or sector relation as explained above, used two or more co-channel or adjacent channel frequencies, interference may significantly increase regarding these cells, which may also affect communication quality or lead to communication failure. Further, if two cells used two or more co-channel or adjacent channel frequencies and the calculated frequency interference probability of at least one of these cells towards the other one is above a predetermined threshold for one or more of these frequencies, interference may also increase beyond a tolerable limit and communication quality may decrease.

Hence, an assignment of co-channel or adjacent channel frequencies within a cell or to cell pairs with a certain cell relation or with a certain frequency probability lying above a tolerable limit is to be avoided. Otherwise, an assignment of co-channel or adjacent channel frequencies may be admitted to cell pairs, if their interference lies within tolerable limits.

The differentiation between co-channel frequency relations and adjacent channel frequency relations allows the definition of different degrees of freedom in the frequency assignment regarding different intra-cell and inter-cell frequency approaches depending on what degree of interference may be tolerable or not. For example, for different ones of the frequency combiner distance condition, cell neighborhood condition, cell sector condition or frequency interference probability condition, as explained above, different forbidden frequency relations can be defined, each comprising different combinations of co-channel and adjacent channel frequency relations.

The frequency relations distinguish between control channel frequencies and traffic channel frequencies. Control channel frequencies and traffic channel frequencies may be defined as explained above. Depending on the intra-cell or inter-cell frequency assignment and depending on the relations between respective cell pairs, control channel frequencies and traffic channel frequencies each may have different significance regarding a negative impact caused by frequency interference. For example, when the control channels have a more fundamental role than the traffic channels, the respective frequency relations can be defined such that an optimized frequency assignment keeps interference impact regarding control channel frequencies in a limit smaller than the tolerable interference limit regarding traffic channel frequencies.

Hence, the differentiation between control channel frequencies and traffic channel frequencies in the respective frequency relations allows the definition of different degrees of freedom in the frequency assignment regarding different intra-cell and inter-cell frequency approaches depending on the different significance of control channels and traffic channels and what degree of interference may be tolerable for both or not. For example, for different ones of the frequency combiner distance condition, cell neighborhood condition, cell sector condition or frequency interference probability condition, as explained above, different forbidden frequency relations can be defined, each comprising different combinations of control channel frequencies and traffic channel frequencies.

In at least one example considering at least one of the frequency demand condition, frequency combiner distance condition, cell neighborhood condition, cell sector condition or frequency interference probability condition, as explained above, the method further comprises the following steps:
specifying frequency variables, wherein each frequency variable is associated with one cell within the mobile communications network and one frequency for this cell,
formulating the frequency relations of the respective condition as terms of selected frequency variables, and
calculating the frequency relations of the respective condition, by using the quantum concept processor, to set the frequency variables, such that the respective frequency relations become zero.

In this way, the respective condition can be flexibly modelled and optimized by using the quantum concept processor to respectively set the frequency variables, such that the respective condition is fulfilled if possible. This offers an elegant example of the respective condition as a (hard) constraint to the optimization problem formulated in the stress function. By considering such constraints in the formulation or calculation of the stress function, solutions of the optimization problem can be penalized that contravene the above conditions. This enables finding suitable optimized solutions considering practical constraints of the actual network conditions of the communications network. The frequency variables used in formulating the frequency relations of the respective condition can be partially or fully those frequency variables used in formulating the terms of the stress function as explained above.

The calculated frequency interference probabilities of respective cell pairs distinguish between co-channel frequency interference probabilities and adjacent channel frequency interference probabilities. The co-channel frequency interference probabilities are calculated for frequencies of a same channel between the cells of respective cell pairs and the adjacent channel frequency interference probabilities being calculated for frequencies of adjacent channels between the cells of respective cell pairs. In this way, different interference probabilities can be calculated and considered depending on the different interference characteristics of co-channel or adjacent channel frequencies, as explained above in the context of co-channel or adjacent channel frequency relations.

The stress function is formulated as a quadratic unconstrained binary optimization (QUBO) function. This QUBO function is “input” for the quantum concept processor that solves this optimization problem for an optimized assignment of frequencies according to our method. Generally speaking, QUBOs are quadratic order polynomials in binary variables which are represented in a quantum concept processor as bits or quantum bits (Q-bits hereinafter). In the context of the optimization problem of this disclosure, the QUBO function represents the sum of potential contributions of the calculated frequency interference probabilities of respective cell pairs as a function of different Q-bits. Each Q-bit represents the selection of one frequency of one cell and can attain the value “0” or the value “1” (or both with a certain probability). To solve the optimization problem, the quantum concept processor runs through different settings of the different Q-bits to find such solution(s) that minimize the optimization problem. In this way, a QUBO representation of the optimization problem has elegant properties regarding the applied quantum concept computing. For example, the above explained frequency variables are formulated in the form of such Q-bits.

The stress function and one or more of the above explained conditions are combined into a global QUBO function. In the global QUBO function, hence, one or more of the above-explained constraints and the optimization target can be considered. In this regard, one or more of the above-explained constraints can be weighted within the QUBO function as soft constraints. In this regard, soft constraints are constraints that are desired but do not have to be met if the cost function attains a substantially better value. This has the advantage that the QUBO function can be somewhat fine-tuned depending on the focus of the optimization problem either on the optimization of the frequency assignment to the cells throughout the network with respect to interference probabilities or on the fulfilment of one or more of the mentioned (soft) constraints.

The method may further comprise the following steps:
specifying a subset of unplanned cells from the set of unplanned cells,
performing the method for the subset of unplanned cells,
updating the cells in the subset to planned cells with their determined optimized assignment of frequencies, and
iteratively performing the method for the remaining unplanned cells of the set of unplanned cells until all unplanned cells of the set of unplanned cells are processed.

In this way, a kind of decomposition strategy can be followed. This has the advantage of or is even necessary for processing the explained method despite limited hardware performance of the quantum concept processor for solving the optimization problem. Assuming a high number of required frequency variables to formulate the optimization problem and/or one or more of the additional conditions/constraints, as explained above, the possibilities of current quantum concept processors are still limited. Hence, the very complex optimization problem has to be decomposed into several partial solutions that can be iteratively processed to find an optimal solution. In each iteration one partial solution is found by the quantum concept processor.

For example, the hardware limitations manifest themselves under consideration of a QUBO formulation of the optimization problem, as explained above, where the number of required bit variables (Q-bits) to formulate the optimization problem depends e.g. on the number of cells and the number of frequencies (potentially assigned or already planned) to each cell. Hence, for n unplanned cells with m frequencies per cell, at least n×m Q-bits must be specified. Q-Bits for already planned cells can be set constant. Additionally, for each frequency, a control channel and traffic channel characteristic is to be distinguished in the respective frequency relations, the number of required Q-bits further increases to 2×n×m, since n×m Q-bits for a control channel frequency assignment and n×m Q-bits for a traffic channel frequency assignment must be specified.

For example, considering a GSM communications network that may comprise thousands of GSM cells to be planned and tens or hundreds of frequency bands or channels, the number of required Q-bits may quickly reach a dimension of hundreds of thousands. Taking further into account that a typical quantum concept processor nowadays can solve optimization problems in the order of 10.000 bit variables (Q-bits), the overall optimization problem has to be addressed iteratively with the help of a problem decomposition by the above-explained measures.

According to a strategy for specifying/building the subset of unplanned frequencies, the following steps are performed. In a first step candidates of unplanned cells are sorted/prioritized in a descending order according to the number of certain constraints or cell relations with regard to already planned cells. For example, first those one or more unplanned cells are considered, which have the most cell relations to already planned cells or whose frequency assignment procedure is influenced the most by constraints of already planned cells in terms of potential frequency interference. This has the advantage that initially those one or more unplanned cells are considered whose planning (frequency assignment) is most restricted by the interference characteristics to already planned cells in the network. These unplanned cells are then included first in the subset of unplanned cells.

In a second step, further candidates of unplanned cells are selected according to certain constraints or cell relations with regard to cells that are already included in the subset of unplanned cells. This has the advantage that in the second step those further unplanned cells are considered whose planning (frequency assignment) might have the most impact regarding the interference characteristics to cells which are already in the subset of unplanned cells. These unplanned cells are then included in the subset of unplanned cells, too.

The first and/or the second steps are iteratively performed until an upper limit of frequency variables (Q-bits) is reached that can be calculated at a time by the quantum concept processor. Then, the method is performed for the built subset of unplanned cells. After the frequency assignment has been calculated for the subset of cells, these are updated to planned cells with their determined optimized assignment of frequencies. Subsequently, the method is iteratively performed for the remaining unplanned cells of the set of unplanned cells until all unplanned cells are processed.

The above-mentioned problem is also addressed by a quantum concept processor as claimed in the enclosed claims. The quantum concept processor is configured for performing one or more steps of a method as described above. According to an example, the quantum concept processor is a digital annealing processing unit. This unit can be specially configured to perform quantum annealing or a quantum annealing emulation as explained above. The quantum concept processor can be of any type explained above.

Moreover, the above-mentioned problem is also addressed by a computer program comprising instructions that, when the program is executed by one or more processors, cause each of the one or more processors to perform one or more steps of a method as described above. At least one of these processors is e.g. a quantum concept processor as explained above. Other processors can be configured for processing, by executing the computer program, preparatory or iterative steps of or for a method as explained above. The computer program can be stored on a computer-readable storage medium.

Moreover, the above-mentioned problem is also addressed by a workplace for a network planner, configured for verifying an optimized assignment of frequencies determined by a method as described above. Such a workplace, for example, has verification means that are configured for an (automated or semi-automated) verification of an optimized assignment of frequencies determined by a method as described above. This is a network planner to verify optimization results found by a method as described above. The verification means can be implemented in software and/or hardware. For example, the workplace can communicate or be connected to a system comprising a quantum concept processor that performs the method as described above. The results can then be taken over into the workplace.

Moreover, the above-mentioned problem is also addressed by an interface arrangement comprising one or more interfaces to cells of a mobile communications network, the cells being distributed for communication within the mobile communications network, wherein the interface arrangement is configured to automatically deploy an optimized assignment of frequencies determined by a method as described above to the cells of the mobile communications network. In this way, an optimized assignment of frequencies determined by a method as described above can be (automatically or semi-automatically) be deployed to a plurality of cells of a respective mobile communications network. For example, the interface arrangement can communicate or be connected to a workplace as describe above or to a system comprising a quantum concept processor that performs the method as described above. The results can then be taken over into the interface arrangement.

Moreover, as preparatory measure for one or more of the above-explained steps of the computer-implemented procedure, an interface can be implemented or used for reading out parameters from the communications network before a respective optimization and for inputting such parameters into the explained computer-implemented optimization procedure. In this way a closed loop continuous optimization is possible. The parameters, for example, comprise a network configuration, adjacency information or relations of respective cells of the network, available frequencies in the network and frequency demands of respective cells to be expected.

Any aspects, features, effects and measures described alone or in combination with each other of the method explained above can be applied to or find analogous representation in aspects, features, effects and measures described alone or in combination with each other in the context of the quantum concept processor, the computer program, workplace and interfaces explained above, and vice versa.

Our methods are further described below under consideration of several examples with the aid of multiple drawings.

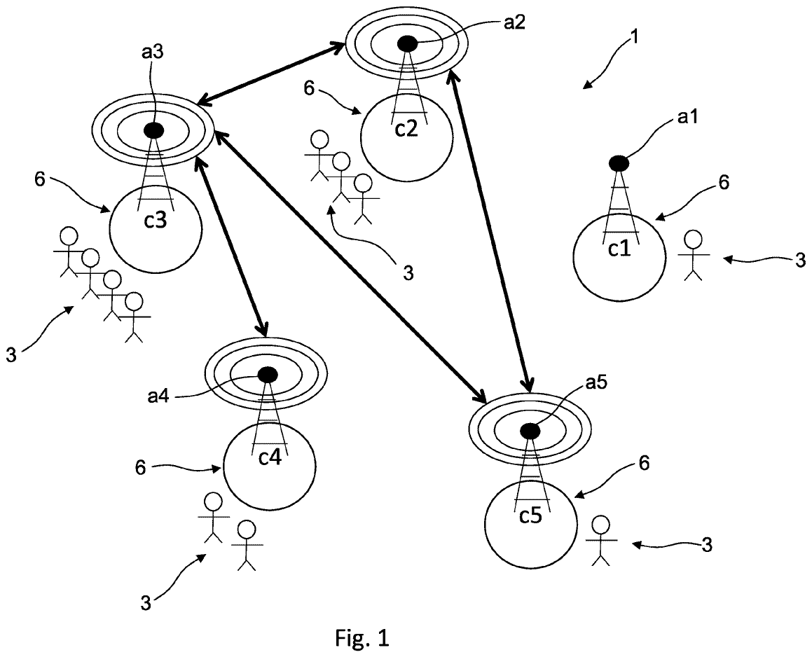

FIG. 1 shows an example of a configuration of a part of a communications network 1 with a plurality of cells. For example, the communications network 1 is a GSM network and comprises approximately 50.000 GSM cells. Exemplary illustrated in FIG. 1 are cells c1 to c5. Each of the cells c1 to c5 has an antenna a1 to a5, respectively. Hence each cell c1 to c5 spans a region of coverage of mobile radio communication by the respective antenna a1 to a5. Depending on the transmission power characteristics and installation of an antenna a1 to a5 as well as the topology of its surroundings, the areal coverage of the cells c1 to c5 spanned by the antennas a1 to a5 can vary.

In the example configuration of FIG. 1, each of the cells c2 to c5 provide a communication node for participants 3 (mobile phones and other cellular or radio communication devices) that may connect to a respective cell through radio communication over certain frequencies. Each cell c2 to c5 covers a certain area for mobile communications networking. Frequencies are discrete frequency bands or channels. For example, the communications network 1 comprises 100 frequency channels, wherein approximately three to five channels are used per cell. If hopping is used, the channels to be used per cell may be 1 to 12, for example. In the example configuration of FIG. 1, cells c2 to c5 each uses certain frequencies assigned to the respective cell. The frequencies are assigned to the cells c2 to c5 such that an interference (signal disturbance) between the cells c2 to c5 (see arrows between cells c2 to c5 in FIG. 1) can be avoided or at least kept as low as possible.

In contrast to the cells c2 to c5, the cell c1 of FIG. 1 does not have frequencies already assigned to this cell. This means that cell c1 is an unplanned cell 2, whereas the other cells c2 to c5 are each planned cells 6. Cell c1, however, is to be assigned certain frequencies, such that also between cell c1 and other cells c2 to c5 an interference (signal disturbance) can be avoided or at least kept as low as possible and, hence, cell c1 also becomes a planned cell.

In this regard, a frequency assignment procedure is performed according to which an automated, computer-implemented frequency assignment to unplanned cells 2 within the communications network 1 is executed. An optimization target of such a frequency assignment lies in minimization of frequency interference as best as possible between respective cells of the communications network 1, thereby still allocating a required number of frequency channels to as many unplanned cells as possible.

The number of frequency channels required for each cell depends on the number of mobile communication participants 3 that aim to dial into the network 1 and use the communications topology of the communications network 1. As illustrated in the example configuration according to FIG. 1, the cells c1 and c5 are associated with the smallest number of participants 3. For example, cells c1 and c5 are located in a rural region without a dense communication demand. Cell c4 requires more participants 3 than cells c1 and c5. Cell c4, for example, is located in a town where a small demand for communications is present. In contrast, cells c2 and c3 each have the highest number of participants 3 that wish to use the communications network 1. Cells c2 and c3 are, for example, installed in cities with dense urban infrastructure. In the example configuration of FIG. 1, therefore, cells c1 and c5 require the smallest number of frequency channels, whereas cells c2 and c3 require the highest number of frequency channels.

Regarding cell c1, frequencies are to be assigned to this unplanned cell 2 such that cell c1 causes as little frequency interference as possible to the other cells within communications network 1, but still gets the required number of channels to provide a mobile communication node for the participants 3, requesting communication within cell c1. In other words, the optimization problem to be addressed regarding cell c1 lies in determining an optimized frequency assignment to cell c1 (and potentially to other cells c2 to c5, if a frequency re-assignment is considered for these cells) in the communications network 1. This means that, for the respective cell c1 (and potentially other cells), a sub-set of frequencies from a respective set of potential frequencies is selected, such that a mathematically formulated quadratic stress function (core optimization problem) is minimized. This serves the purpose, and has the technical effect, of choosing respective sub-sets of frequencies that meet the required frequency demands of each unplanned cell 2 in the network 1, depending on the number of participants 3 per cell, combined with the effect that an intra-cellular and/or an inter-cellular frequency interference can be minimized and nevertheless dense frequency usage over the whole frequency spectrum available within the network 1 can be enhanced. This has the effect that user experience can be enhanced and degradation of communication quality or communication failure can be avoided, thereby still enabling the participation in and usage of the communications network 1 by as many participants as possible. The sub-set of frequencies assigned to each unplanned cell can be selected out of a predetermined set of frequencies that can potentially be assigned to an unplanned cell 2, in FIG. 1 cell c1 (and potentially other cells).

To achieve the above advantageous effects, a computer-implemented algorithmic method for optimizing the frequency assignment to unplanned cells 2 within the communications network 1 is implemented. This is further explained below. In addition to such a core optimization problem, additional partial optimization problems are taken into account which represent conditions (constraints) to be met in the optimization process. These constraints consider that there are certain intra-cell and inter-cell frequency relations and certain cell relations that influence the assignment of frequencies to each cell in terms of an optimized minimization of frequency interference and a fulfilment of the required frequency demand per unplanned cell 2. Such conditions and constraints are explained in the following.

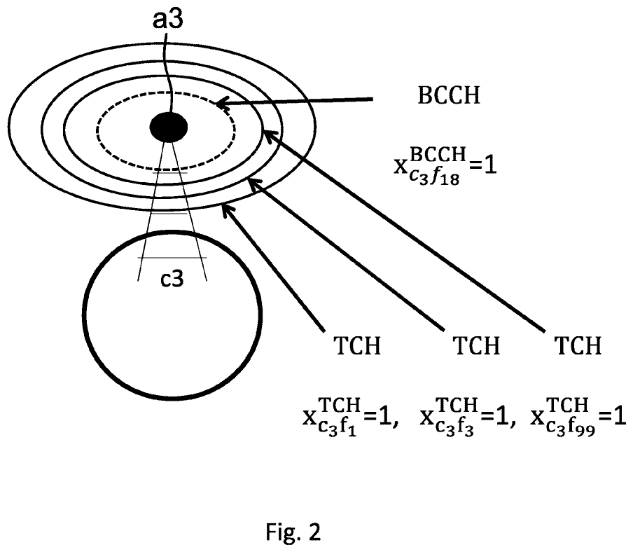

FIG. 2 shows an example of a configuration of the cell c3 to which predetermined frequencies are assigned. Cell c3, thereby, meets certain conditions which are also applicable to and must be met by the other cells within the communications network 1, in particular with regard to unplanned cells 2 to which frequencies are to be assigned.

FIG. 2 illustrates a differentiation between two basic types of frequencies to be used within the cells of the communications network 1. These two types of frequencies distinguish so-called broadcast channel, BCCH, frequencies and traffic channel, TCH, frequencies. In the example, one BCCH frequency must be assigned to each cell. The BCCH frequency is necessary for each cell and serves the purpose of providing a control channel for the cell via which signaling and control information is exchanged between the cell and other cells or the cell and different network elements, terminals or participants. The TCH frequencies serve the purpose of providing one or more traffic channels for each cell over which communication traffic, like data or voice, is transmitted and exchanged between the cell and other cells or the cell and different network elements, terminals or participants. The BCCH frequencies can be configured to also transmit a part of the communication traffic in the communications network besides the signaling and control information. Alternatively, the BCCH frequencies are configured to only transmit signaling and control information. For example, a signal transmission of different participants 3 in the network 1 (see FIG. 1) is configured as time-multiplexing transmission, wherein each participant using a respective frequency of a respective cell is assigned a time slot (e.g. in the range of milliseconds) in which signaling assigned to this participant is transmitted.

As illustrated for cell c3 in FIG. 2, each cell within the communications network 1 has to meet a certain frequency demand of the respective cell. As explained above, such a frequency demand depends on the number of participants 3 dialing into the communications network 1 and may also depend on the topology of the mobile communications network 1, location and/or cellular characteristics of each cell (depending on power transmission, performance and/or topology of surroundings of the cell). The frequency demand defines a number of frequencies to be assigned to a respective cell. This number can be preselected or predetermined depending on the above-explained parameters. As illustrated in FIG. 2, cell c3 has a frequency demand of four, which means that four frequencies are to be assigned to cell c3. As explained, one frequency is a BCCH frequency. In the example of FIG. 2, frequency f18 is assigned as BCCH frequency of cell c3. Moreover, the rest of the assigned frequencies, which means the other three frequencies, are assigned as TCH frequencies. In the example of FIG. 2, frequencies f1, f3 and f99 are assigned as TCH frequencies to cell c3.

As further illustrated in FIG. 2, certain frequency variables x_{cf} are defined which, depending on the characteristics of a frequency being a BCCH frequency or a TCH frequency, are associated with one cell c within the mobile communications network 1 and one frequency f for this cell c. A frequency variable x_{cf} here attains the value “0” if the respective frequency f is not assigned to the respective cell c, and attains the value “1” if the respective frequency f is assigned to the respective cell c. As illustrated in FIG. 2, the frequency variable

$${X}_{c 3 f 18}^{BCCH} = 1 ,$$

since frequency f18 is assigned to cell c3 as BCCH frequency. The other three frequency variables are also set to to

$${X}_{c 3 f 1}^{TCH} = 1 ,$$

$${X}_{c 3 f 3}^{TCH} = 1$$

$$and$$

$${X}_{c 3 f 99}^{TCH} = 1 ,$$

since, as explained before, the frequencies f1, f3 and f99 are assigned as TCH frequencies to cell c3. All other frequency variables xc3f for cell c3 are “0”. The formulation in terms of such frequency variables serves the purpose of a mathematical formulation of the above-mentioned constraints and the above-mentioned core optimization problem that is further explained below.

In addition to a frequency demand condition, cell c3 as illustrated in FIG. 2, must also meet a so-called frequency combiner distance condition. This means that for each cell c, in particular for each unplanned cell 2, forbidden frequency relations are defined such that the frequencies f assigned to each cell have a certain channel distance. In the configuration as illustrated with regard to FIG. 2, such channel distance may have, for example, the value ≥2. This means that each frequency f assigned to a respective cell must have a frequency distance of ≥2 to other frequencies f of the cell. This requirement describes that so called co-channel frequencies and adjacent channel frequencies are forbidden for each cell. Co-channel frequencies relate to frequencies f of a same channel and adjacent channel frequencies relate to frequencies f of adjacent channels. This is the purpose of avoiding intra-cell interference between the frequencies assigned to each cell. As illustrated for cell c3 in FIG. 2, the frequency combiner distance condition is fulfilled, since all frequencies f1, f3, f18 and f99 have a distance of ≥2.

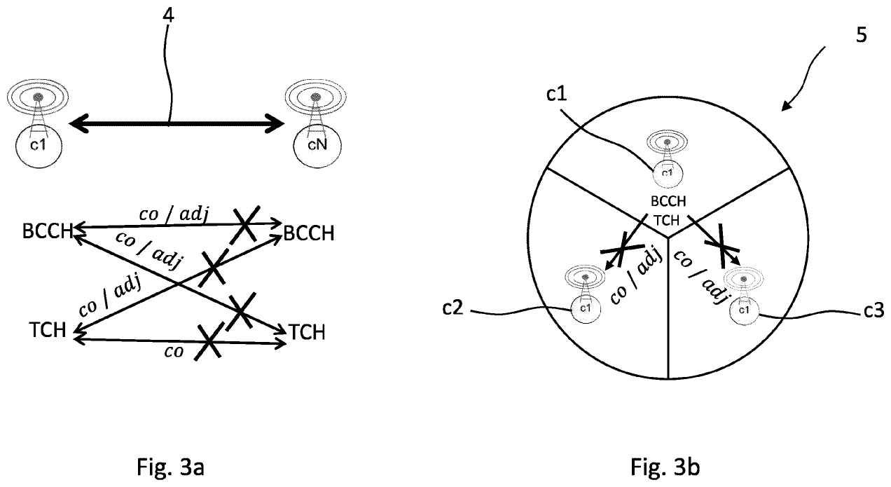

FIG. 3a illustrates a further condition which must be fulfilled as an additional constraint. FIG. 3a illustrates a so-called cell neighborhood condition, which means that for those cells c which have a determined neighborhood relation 4, forbidden frequency relations between these cells c are defined. As illustrated in FIG. 3a, cells c1 and cN are considered to be in a neighborhood 4. Hence, such a neighborhood relation 4 here describes neighboring cells that provide an overlap in their area coverage. For the cells c within a neighborhood 4, certain combinations of frequencies are forbidden from being assigned to the respective cell pair. As illustrated in FIG. 3a, a BCCH frequency of cell c1 must not be a co-channel (co) or adjacent channel (adj) frequency of the BCCH frequency of cell cN. Moreover, the BCCH frequency of cell c1 must not be a co-channel or adjacent channel frequency of a TCH frequency of cell cN. Moreover, a TCH frequency of cell c1 must not be a co-channel or adjacent channel frequency of the BCCH frequency of cell cN. Last but not least, a TCH frequency of cell c1 must not be a co-channel frequency of a TCH frequency of cell cN. Nevertheless, in the latter instance, a TCH frequency of cell c1 can be an adjacent channel frequency to another TCH frequency of cell cN. In other words, TCH frequencies of neighboring cells must not be co-channel frequencies, but can be adjacent channel frequencies.

The cell neighborhood condition serves the purpose of ensuring a reliable handover of certain mobile communication participants travelling between the area coverage of neighboring cells. If a participant moves away from the antenna (center) of one cell during ongoing usage of the mobile communications network, for example, cell c1 in FIG. 3a, its transmission level decreases. As soon as the participant reaches the area of the next neighboring cell, for example, cell cN, the participant must be handed over from cell c1 to cell cN. For this purpose, continuous signal measurements are necessary to change between frequencies of cells c1 and cN. If interference between cells c1 and cN was high, such measurements would fail and, consequently a handover might also fail, which leads to abort of communication. The frequency relations, as defined by the cell neighborhood condition explained above, ensure that the frequency interference between neighboring cells, in FIG. 3a exemplary c1 and cN, is kept in tolerable limits such that the handover between neighboring cells is reliably guaranteed or a handover failure risk is kept below a tolerable limit.

FIG. 3b illustrates a further condition, named cell sector condition. Cells c1, c2 and c3 are located within a certain sector 5. The sector 5, for example, defines a predetermined dense installation area or location, where multiple antennae of different cells, c1 to c3 in this example, are installed close to each other, for example, on a rooftop, in a street or in a dense urban area. The cell sector condition may define more restricting frequency relations than the cell neighborhood condition as explained with regard to FIG. 3a above. This means that the cell sector condition according to FIG. 3b may define stricter rules for forbidden frequency relations between respective cells (cell pairs) than the cell neighborhood condition.

With regard to FIG. 3b, as illustrated, the BCCH and TCH frequencies of one respective cell, for example, cell c1, must not be a co-channel (co) or adjacent channel (adj) frequency of the frequencies of the other cells, for example, cells c2 or c3. This means that all frequencies of cell c1 must have a frequency distance to all other frequencies of cells c2 and c3 with a value of ≥2. The cell sector condition, hence, serves the purpose of avoiding inter-cell interference which may be significant due to the dense installation and overlap of different cells in the sector 5.

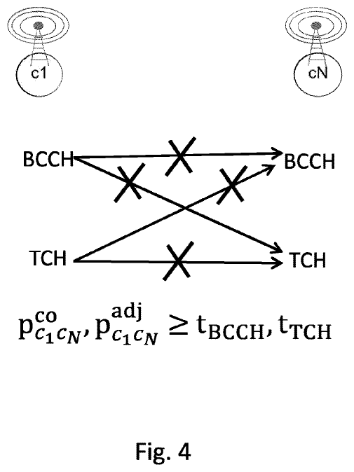

FIG. 4 illustrates a further condition which is to be met. This further condition is a so-called frequency interference probability condition, which means that forbidden frequency relations between the cells of those cell pairs in the mobile communications network are defined whose frequency interference probabilities p are above a predetermined threshold t. In the exemplary illustration of FIG. 4, the cell pair of cells c1 and cN is regarded. Moreover, it is distinguished between a co-channel frequency interference probability

$${p}_{c 1 cN}^{co}$$

and an adjacent channel frequency interference probability

$${p}_{c 1 cN}^{adj} .$$

Moreover, it is distinguished between a threshold for the BCCH frequency t_{BCCH} and a threshold for the TCH frequencies t_{TCH}. If one or both of the co-channel frequency interference probability and the adjacent channel frequency interference probability is greater than or equal to one of the thresholds, such that

$${p}_{c 1 cN}^{co} , {p}_{c 1 cN}^{adj} \geq {t}_{BCCH} , {t}_{TCH} ,$$

certain frequency relations are forbidden respectively. This means that the BCCH frequency of cell c1 must not be the BCCH frequency of cell cN, either regarding the co-channel or the adjacent channel frequency, depending on whether one or both of the respective frequency interference probabilities is equal to or greater than the respective threshold t_{BCCH}. Moreover, the BCCH frequency of cell c1 must not be a TCH frequency of cell cN, either regarding co-channel or adjacent channel frequencies, depending on whether one or both of the respective frequency interference probabilities is equal to or greater than the respective threshold t_{BCCH}. Analogously, a TCH frequency of cell c1 must not be the BCCH frequency of cell cN, either regarding co-channel or adjacent channel frequencies, depending on whether one or both of the respective frequency interference probabilities is equal to or greater than the respective threshold t_{TCH}. Finally, a TCH frequency of cell c1 must not be a TCH frequency of cell cN, regarding either of co-channel or adjacent channel frequencies, depending on whether one or both of the respective frequency interference probabilities is equal to or greater than the respective threshold t_{TCH}. The analogous restrictions apply for the interchanged roles of c1 and cN and the interference probabilities

$${p}_{cNc 1}^{co} , {p}_{cNc 1}^{adj} .$$

In this way, an inter-cell frequency interference must be within tolerable limits between respective cell pairs, between cell pair c1 and cN, to prevent adverse effects leading, in the worst situation, to communication failure. Even if an overall assignment of frequencies results in an increased interference probability, p^{co} or p^{adj}, between some cells or in certain regions or areas of the network after all unplanned cells have been planned and assigned their respective frequencies, the interference probability can nevertheless be kept within tolerable limits, since it is avoided that the respective frequency interference probabilities are equal to or greater than predetermined thresholds t_{BCCH} and t_{TCH} for respective BCCH and TCH frequencies.

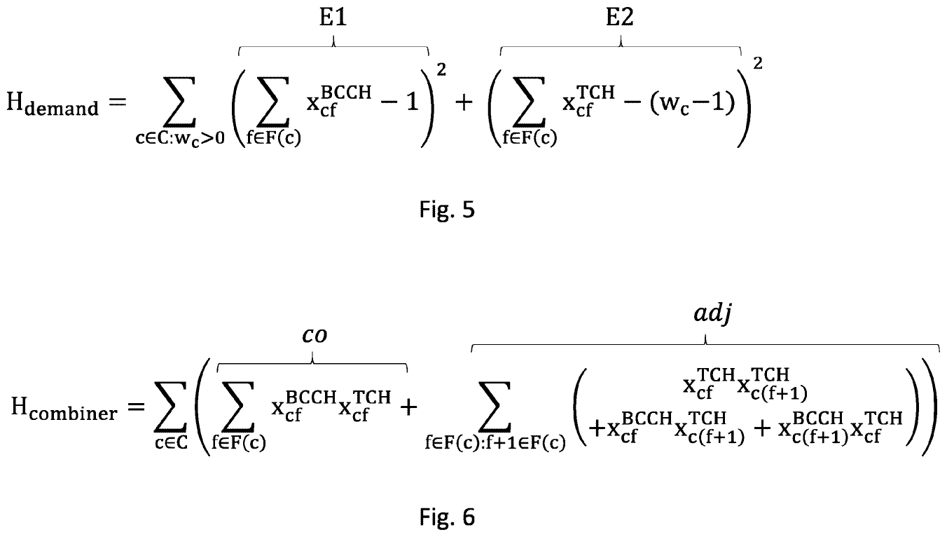

FIGS. 5 to 9 show mathematical formulations of the conditions/constraints as explained above. In this regard, the following nomenclature is defined:

$$\begin{matrix}F = \{ 0 , 1 , … , M \} : & set of all frequencies \\ C = \{ 0 , 1 , … , N \} : & set of all cells \\ SEC ⊂ C \times C : & tuples of cells which have sector relations \\ NB ⊂ C \times C : & tuples of cells which have neighborhood relations .\end{matrix}$$

∀c∈C and ∀f∀F\F(c):

$${x}_{cf}^{BCCH} = {x}_{cf}^{TCH} = 0$$

as fixed bits.

The mathematical formulations of FIGS. 5 to 9 are represented as so-called Hamiltonian functions, abbreviated to Hamiltonians, and represent QUBO formulations of Q-Bits as explained above.

The mathematical formulation of FIG. 5 formulates the frequency demand condition as explained above with regard to FIG. 2. The mathematical formulation in FIG. 5 is formulated as summed terms containing binary frequency variables

$${x}_{cf}^{BCCH} and {x}_{cf}^{TCH}$$

for respective BCCH and TCH frequencies that can attain the value “0” or the value “1” (or both with a certain probability) and are represented in a quantum concept processor as bits (or Q-bits as used hereinafter). Hence, the binary frequency variables according to FIG. 5 are configured as explained above in view of FIG. 2. For each cell c of the set of all cells C within the network 1 and for each frequency f of the frequencies F(c) to be potentially assigned to each cell c a respective Q-bit can be set. If the respective frequency shall be a BCCH frequency, the

$$Q - bit {x}_{cf}^{BCCH}$$

is respectively set. Otherwise, if a respective frequency shall be a TCH frequency, the respective

$$Q - bit {x}_{cf}^{TCH}$$

is respectively set. The respective

$$Q - bit {x}_{cf}^{BCCH} , {x}_{cf}^{TCH}$$

is set to the value “1” if a respective frequency is set accordingly. The respective

$$Q - bit {x}_{cf}^{BCCH} , {x}_{cf}^{TCH}$$

is set to the value “0”, if not.

Considering the formulation of the Hamiltonian of FIG. 5, the Hamiltonian at an optimal solution must be equal to zero. This is only fulfilled if the two terms E1 and E2 each become zero. This is the instance if for all cells c out of the set C exactly one frequency f out of potential frequencies F(c) is assigned as BCCH frequency and the other frequencies f of the number wc of demanded frequencies are assigned as TCH frequencies. The mathematical formulation according to FIG. 5 enables all unplanned cells, and advantageously all cells within the network 1, to meet the frequency demand condition as explained above in view of FIG. 2.

The mathematical formulation in FIG. 6 formulates the frequency distance combiner condition, as also explained above in view of FIG. 2. This Hamiltonian sums terms of frequency relations combining

$$Q - bits {x}_{cf}^{BCCH} , {x}_{cf}^{TCH} ,$$

distinguishing different combinations of BCCH or TCH frequencies respectively for co-channel (co) or adjacent channel (adj) frequencies. Co-channel frequencies are considered by combinations of Q-bits regarding the same frequency f, whereas adjacent channel frequencies are considered by respective combinations of Q-bits regarding frequencies f and f+1. The mathematical formulation of FIG. 6, therefore, considers for all unplanned cells c out of the set C and for all frequencies f out of potential frequencies F(c) the condition, as explained above in view of FIG. 2, that each frequency f within a respective cell c must have a distance to other frequencies f≥2.

Considering the formulation of the Hamiltonian of FIG. 6, the Hamiltonian at an optimal solution must be zero. This is only fulfilled if the respective frequency relations (combinations of product terms) each attain the value “0”. This means that at least one of the respective Q-bits of one product term must attain the value “0”. Otherwise, if both Q-bits of a respective product term attain the value “1”, the condition of FIG. 6 would not be fulfilled and the frequency combiner distance condition could not be met.

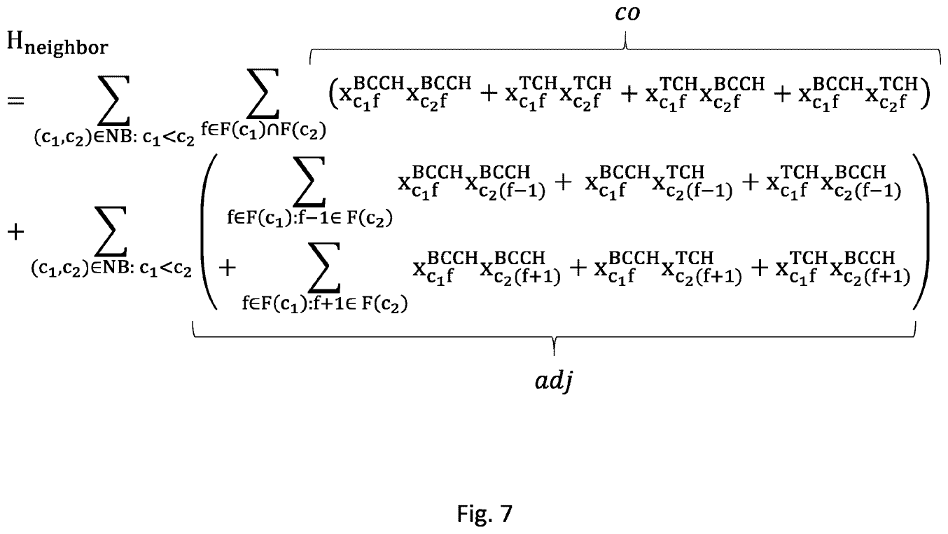

The mathematical formulation of the Hamiltonian according to FIG. 7 represents the cell neighborhood condition as explained above in view of FIG. 3a. In FIG. 7, all cell pairs c1, c2 are regarded that have a neighborhood relation NB where at least one of the cells c1, c2 is unplanned. For example, the neighboring cells c1, cN as explained to FIG. 3a are comprised.

The Hamiltonian of FIG. 7 is formulated as summed terms for all co-channel (co) frequencies f between cell pairs c1, C2 and all adjacent channel (adj) frequencies f, f+1 or f, f−1 between the cell pairs c1, C2 considering respective combinations of Q-bits as regards combinations of BCCH and/or TCH frequencies. Hence, the Hamiltonian according to FIG. 7 represents a mathematical formulation of the forbidden frequency relations as explained with regard to FIG. 3a. Considering the formulation of the Hamiltonian of FIG. 7, the Hamiltonian at an optimal solution must be equal to zero. The same applies as explained with regard to FIG. 6. The Hamiltonian of FIG. 7 is only equal to zero if all product terms of combinations of respective Q-bits attain the value “0”. If frequencies f are assigned in such a way that at least one product term of respective combinations of Q-bits attains the value “1”, the condition of FIG. 7 would not be fulfilled.

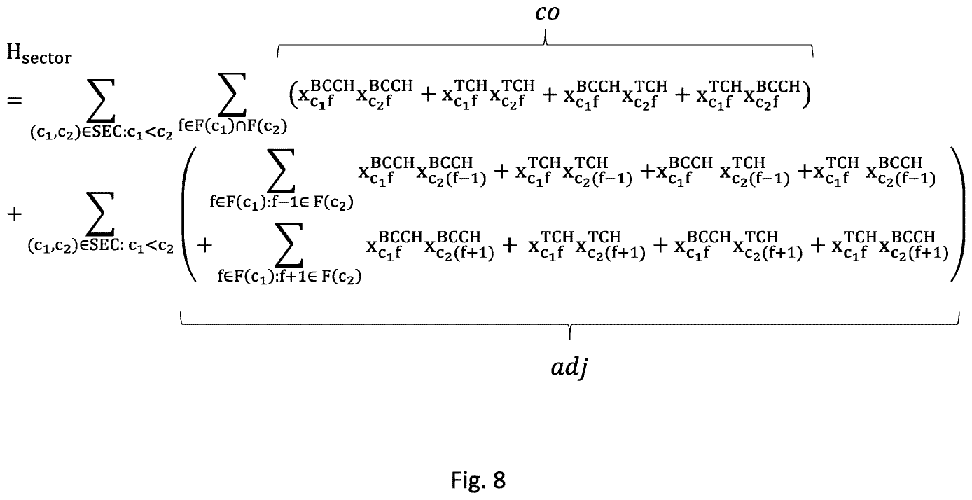

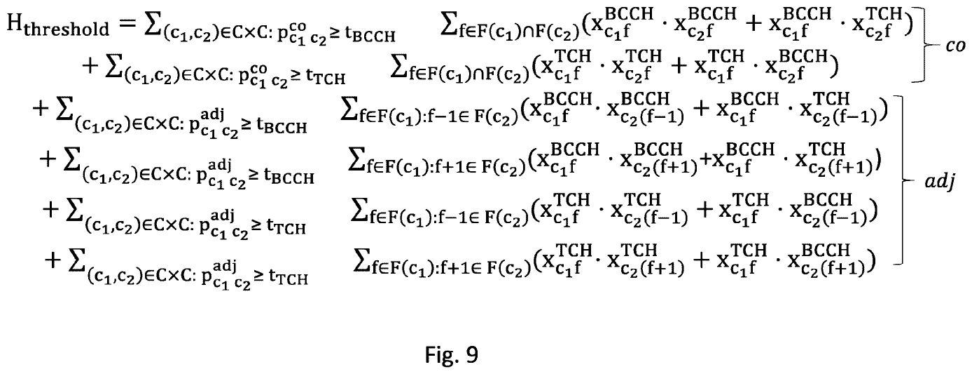

Analogous explanations as to FIG. 7 apply to the mathematical formulations of FIGS. 8 and 9.

FIG. 8 represents the cell sector condition as explained above in view of FIG. 3b. In FIG. 8, all cell pairs c1, c2 are regarded that have a sector relation SEC. The cells c1, c2 in FIG. 8 represent all cell pairs that have a sector relation in the network for which at least one of the cells c1, c2 is unplanned. For example, the cell pairs c1, c2 and c1, c3 of sector 5 as explained to FIG. 3b are comprised. For all respective cell pairs c1, c2 the Hamiltonian of FIG. 8 is only equal to zero if all product terms of combinations of respective Q-bits attain the value “0”. If frequencies f are assigned in such a way that at least one product term of respective combinations of Q-bits attains the value “1”, the condition of FIG. 8 would not be fulfilled.

FIG. 9 represents the frequency interference probability condition as explained above in view of FIG. 4. In FIG. 9, all cell pairs c1, c2 are regarded which have a respective condition

$${p}_{c 1 c 2}^{co} , {p}_{c 1 c 2}^{adj} \geq {t}_{BCCH} , {t}_{TCH} .$$

The cells c₁, c₂ in FIG. 9 represent all cell pairs that have such a probability relation in the network for which at least one of the cells c1, C2 is unplanned. For example, the neighboring cells c1, cN as explained to FIG. 4 are comprised. The Hamiltonian of FIG. 9 is only equal to zero if all product terms of combinations of respective Q-bits attain the value “0”. If frequencies f are assigned in such a way that at least one product term of respective combinations of Q-bits attains the value “1”, the condition of FIG. 9 would not be fulfilled.

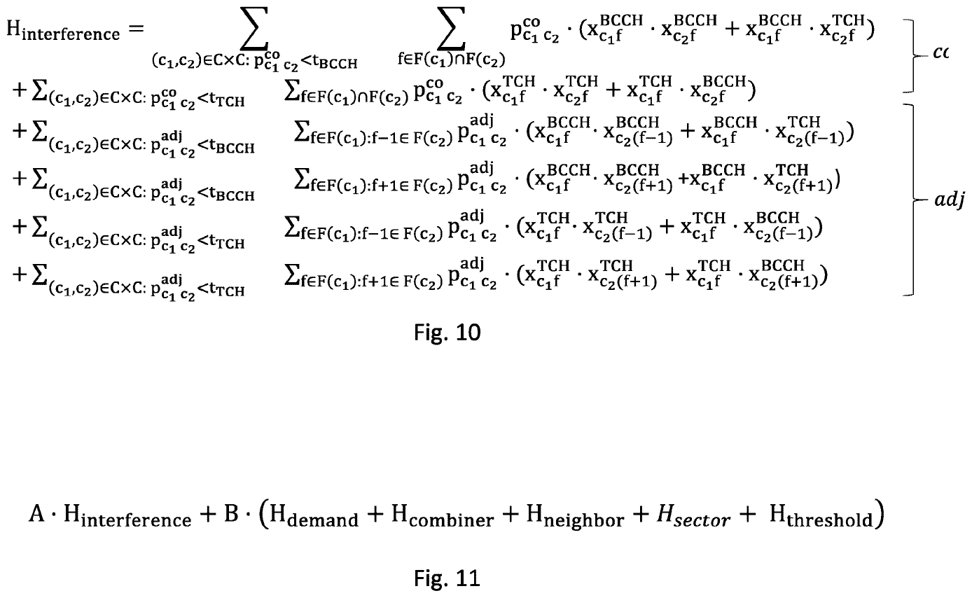

The mathematical formulation of the Hamiltonian according to FIG. 10 represents the core optimization problem, taking into account the calculated frequency interference probabilities

$${p}_{c 1 c 2}^{co} , {p}_{c 1 c 2}^{adj} ,$$

for co-channel (co) frequencies and for adjacent channel (adj) frequencies that are potentially simultaneously assigned between respective cell pairs c₁, c₂. The cells c₁, c₂ in FIG. 10 represent all cell pairs c₁, c₂ that have such a probability relation in the network where at least one of the cells c₁, c₂ is unplanned. Hence, in the core optimization problem of FIG. 10, only frequency interference probabilities are considered that have the condition

$${p}_{c 1 c 2}^{co} , {p}_{c 1 c 2}^{adj} < {t}_{BCCH} , {t}_{TCH}$$

for respective BCCH and TCH frequencies. The core optimization problem lies in minimizing the Hamiltonian according to FIG. 10 i to find optimized frequency assignments for all cell pairs c₁, c₂ such that frequency interference between the cells is minimized.

The Hamiltonian according to FIG. 10 comprises summed terms, each term multiplying a respective frequency interference probability

$${p}_{c 1 c 2}^{co} , {p}_{c 1 c 2}^{adj}$$

with a frequency relation comprising different combinations of different Q-Bits that are set as explained above. In other words, the Hamiltonian of FIG. 10 is formulated as a stress function which penalizes frequency relations between respective cell pairs that lead to frequency interference between the respective cells with the calculated frequency interference probability. If a respective combination of Q-Bits in the respective frequency relations of the terms according to FIG. 10 has the value “1”, this frequency combination is multiplied with the respective frequency interference probability

$${p}_{c 1 c 2}^{co} , {p}_{c 1 c 2}^{adj}$$

and, therefore, contributes with such probability to frequency interference. Thus, the mathematical formulation of FIG. 10 sums all contributions of a respective frequency interference probability

$${p}_{c 1 c 2}^{co} , {p}_{c 1 c 2}^{adj}$$

of all co-channel (co) and adjacent channel (adj) frequencies of all combinations of BCCH and TCH frequencies potentially simultaneously used between respective cell pairs of the unplanned cells.

The Hamiltonian of FIG. 10 is generally optimized for all (partially) unplanned cell pairs in a network by a quantum concept processor that runs through different settings of values for the respective Q-bits, thereby calculating the respective result of the Hamiltonian. The target of doing so is to find the minimum of the Hamiltonian for respectively set values of the Q-bits. As soon as a respective minimum of the Hamiltonian of FIG. 10 is found, the respective values of the Q-bits leading to this minimum are stored and finally define an optimal frequency assignment with regard to cell interference. Other frequencies that are not candidates for co-channel or adjacent channel frequency interference between cell pairs c₁, c₂ of FIG. 10 (which, therefore have a frequency distance ≥2 to all other cells) can be assigned to the respective cells without any further consideration in the Hamiltonian of FIG. 10. Those frequencies are assumed to have a frequency (channel) distance sufficiently high not to play a significant role and contribution to interference between cells.

FIG. 11 finally shows a global QUBO formulation of the overall optimization problem in which the partial optimization problems according to FIGS. 5 to 10 are multiplied with respective weighting factors A and B and summed to the global optimization problem. This global optimization problem is finally processed by applying a computer-implemented algorithm within the quantum concept processor. In this regard, a minimization of the Hamiltonian according to FIG. 10 takes place, thereby considering further optimization constraints as formulated in the Hamiltonians according to FIGS. 5 to 9.

According to FIG. 11, the core optimization problem of FIG. 10 is multiplied with the weighting factor A, whereas a sum of the other optimization constraints according to FIGS. 5 to 9 is multiplied with the weighting factor B. With the aid of these weighting factors, A and B, different weights and focus on different partial optimization problems can be set. If, for example, the factor B is greater than the factor A, the focus is more on the fulfilment of the optimization constraints as explained with regard to FIGS. 5 to 9. The more the factor A is increased towards factor B, the more weight is on the optimization of interference according to the optimization problem formulated in FIG. 10, explained above.

In certain examples, certain constraints are allowed to be violated. For example, the constraint of FIG. 5 (frequency demand condition) may be violated for certain cells. However, also in these approaches, the result of the algorithmic calculation of the method as explained above can be invalid if there is one cell that is not assigned at least one BCCH frequency. The constraint of FIG. 5 can be split into different constraints following the terms E1 and E2 of FIG. 5 separately. The term E1 must be fulfilled for all cells to be planned, whereas the term E2 may be violated for certain cells. For example, the term E1 can be weighted with a factor B and the term E2 can be weighted with a factor C, wherein A<C<B is defined. In this way, the term E2 defines a soft constraint, whereas the term E1 defines a harder constraint. Certain constraints can be flexibly modelled to real approaches and use instances of network planning.

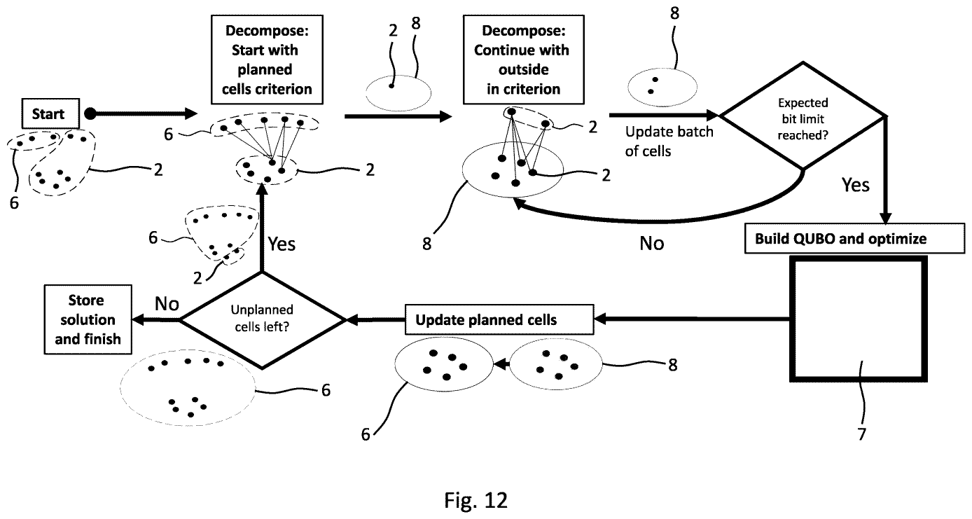

FIG. 12 shows a schematic illustration of an algorithm performing the approach as explained above. FIG. 12 shows the processing of the above-explained method steps and procedure considering the frequency assignment to unplanned cells 2, wherein these unplanned cells 2 are processed in a decomposed manner. This has the advantage of, or is even necessary for, processing the explained method despite limited hardware performance of the quantum concept processor 7 for solving the optimization problem as explained above with regard to FIGS. 5 to 11. This optimization problem (see in particular FIG. 11) is very complex and has to be decomposed into several partial solutions that can be iteratively processed to find an optimal solution. In each iteration one partial solution is found by the quantum concept processor 7.

The process is started with certain planned cells 6 and unplanned cells 2. If there are no planned cells 6, the process is started with one randomly chosen unplanned cell 2. However, if there is one or more already planned cells 6, to decompose the optimization problem, the process is started with a so-called planned cell criterion. This means that in a first step candidates of unplanned cells 2 are sorted/prioritized according to certain constraints or cell relations with regard to already planned cells 6. For example, first those unplanned cells 2 which have the most cell relations to already planned cells 6 are considered whose frequency assignment procedure is influenced the most by constraints of already planned cells 6 in terms of potential frequency interference. These unplanned cells 2 are then included first in a sub-set 8 of unplanned cells 2.

In a second step, the process is continued with a so-called outside in criterion. For this purpose, further candidates of unplanned cells 2 which are not already included in the sub-set 8 of unplanned cells 2 are selected according to certain constraints or cell relations with regard to the cells already included in the sub-set 8 of unplanned cells 2. These unplanned cells 2 are then also included in the sub-set 8. This second step is repeated until an upper limit of the frequency variables (Q-bits) is reached that can be calculated at a time by the quantum concept processor 7. The built sub-set 8 is then input to an algorithmic procedure within the quantum concept processor 7. For example, the quantum concept processor 7 according to FIG. 12 is configured to solve the optimization problem by means of quantum annealing emulation. The quantum concept processor 7 applies the mathematical formulation of the overall optimization problem according to FIG. 11. The quantum concept processor 7 then calculates for the sub-set 8 an optimized solution of the global optimization problem according to FIG. 11.

After the algorithmic procedure is completed, the finally calculated minimum of the global optimization problem according to FIG. 11 is then output from the quantum concept processor 7 for the respective sub-set 8. The cells within sub-set 8 are updated to planned cells 6 with their determined optimized assignment of frequencies. If there are any unplanned cells 2 left, the procedure is iteratively performed for the remaining set of unplanned cells 2 until all cells are planned and processed. In this instance, the global solution for all cells within the communications network is stored. The algorithm is then finished.

Hence, by applying a computer-implemented algorithmic procedure according to FIG. 12, which is based on the examples and explanations above with regard to FIGS. 1 to 11, an optimized frequency assignment can be provided for all cells c within a communications network 1. The process is a hybrid method between pre-processing steps (formation of the respective sub-sets 8) and solution steps by using a quantum concept processor 7. The procedure according to FIG. 12 considers highly conflicting unplanned cells 2 early in the process to allow for a maximal degree of freedom in the optimization. This further improves the solution quality compared to state of the art approaches.

Formulation of the optimization problem as a QUBO representation has elegant properties regarding the applied quantum concept computing within processor 7. Nowadays, quantum concept computing still reaches significant limits. However, with computer science developing more and more towards quantum computing, our approach can be further enhanced and developed in future. For example, when quantum computing is more and more applicable for increasing sizes of underlying optimization problems, the decomposition strategy as explained in view of FIG. 12 can be more and more reduced, which means that the optimization problem can be more and more processed and computed as a whole without decomposition steps and iterations of the problem. Moreover, with quantum computing being more and more applicable, a more and more increasing number of Q-bits, increasingly complex optimization problems and/or more and more non-linear constraints can be taken into consideration by the approach explained herein.

The explained approach is primarily applicable to the assignment of demanded numbers of frequencies to cells within a mobile communications network. The solution can also be used, however, for assignment problems like the planning of line separated mobile phone networks, planning of code separated mobile phone networks or an optimal assignment during operation time, e.g. to react on workload spikes.

The examples illustrated and explained herein are merely exemplary.

1. A computer-implemented method for optimizing an assignment of frequencies to cells of a mobile communications network, the cells being distributed for communication within the mobile communications network, wherein the method comprises the following steps:
specifying a set of unplanned cells in the mobile communications network,
specifying for each unplanned cell a set of frequencies to be potentially assigned to this unplanned cell,
calculating frequency interference probabilities of selected cell pairs, wherein each cell pair defines a relation of an unplanned cell to another cell (c) within the mobile communications network,
formulating terms of a stress function, each term connecting a calculated frequency interference probability of a respective cell pair with a frequency relation between the cells of the respective cell pair, and
determining, by using a quantum concept processor, an optimized assignment of frequencies by selecting for each unplanned cell a sub-set of frequencies from the respective set of frequencies, such that the stress function is minimized.

2. The method according to claim 1, further comprising the following steps:
specifying frequency variables, wherein each frequency variable is associated with one cell within the mobile communications network and one frequency for this cell,
formulating the frequency relations in the terms of the stress function as combinations of selected frequency variables, and
calculating the terms of the stress function, by using the quantum concept processor, to set the frequency variables, such that the stress function is minimized.

3. The method according to claim 1, wherein in the terms of the stress function only calculated frequency interference probabilities are considered that are below a predetermined threshold.

4. The method according to claim 1, wherein the method is performed under consideration of a frequency demand condition that each sub-set of frequencies assigned to an unplanned cell has a specified number of frequencies, wherein one frequency is defined as control channel frequency and the other frequencies are defined as traffic channel frequencies.

5. The method according to claim 1, wherein the method is performed under consideration of a frequency combiner distance condition that for each unplanned cell forbidden frequency relations are defined such that the frequencies of the sub-set of frequencies assigned to this cell have frequency relations with a certain channel distance.

6. The method according to claim 1, wherein the method is performed under consideration of a cell neighborhood condition that for those cells which have a determined neighborhood relation forbidden frequency relations between these cells are defined.

7. The method according to claim 1, wherein the method is performed under consideration of a frequency interference probability condition that forbidden frequency relations between the cells of those cell pairs are defined whose frequency interference probabilities are above a predetermined threshold.

8. The method according to claim 1, wherein the frequency relations distinguish between co-channel frequency relations and adjacent channel frequency relations, and
the co-channel frequency relations being formulated for frequencies of a same channel and the adjacent channel frequency relations being formulated for frequencies of adjacent channels.

9. The method according to claim 1, wherein the frequency relations distinguish between control channel frequencies and traffic channel frequencies.

10. The method according to claim 5, further comprising the following steps:
specifying frequency variables, wherein each frequency variable is associated with one cell within the mobile communications network and one frequency for this cell,
formulating the frequency relations of the respective condition as terms of selected frequency variables, and
calculating the frequency relations of the respective condition, by using the quantum concept processor, to set the frequency variables, such that the respective frequency relations become zero.

11. The method according to claim 1, wherein the calculated frequency interference probabilities of respective cell pairs distinguish between co-channel frequency interference probabilities and adjacent channel frequency interference probabilities, and
the co-channel frequency interference probabilities being calculated for frequencies of a same channel (co) between the cells of respective cell pairs and the adjacent channel frequency interference probabilities being calculated for frequencies of adjacent channels between the cells of respective cell pairs.

12. The method according to claim 1, further comprising the following steps:
specifying a subset of unplanned cells from the set of unplanned cells,
performing the method for the subset of unplanned cells,
updating the cells in the subset to planned cells with their determined optimized assignment of frequencies, and
iteratively performing the method for the remaining unplanned cells of the set of unplanned cells until all unplanned cells of the set of unplanned cells are processed.

13. A quantum concept processor configured for performing the steps of the method according to claim 1.

14. A computer program, the computer program comprising instructions that, when the program is executed by one or more processors, cause each of the one or more processors to perform the method according to claim 1.

15. An interface arrangement comprising one or more interfaces to cells of a mobile communications network, the cells being distributed for communication within the mobile communications network, wherein the interface arrangement is configured to automatically deploy an optimized assignment of frequencies determined by the method according to claim 1 to the cells of the mobile communications network.

16. The quantum concept processor according to claim 13, wherein the quantum concept processor is a digital annealing processing unit.

17. The quantum concept processor according to claim 13, wherein the quantum concept processor is a quantum annealing processing unit.
